(19) United States
(12) Patent Application Publication
(10) Pub. No.: US 2018/0325626 A1
(43) Pub. Date: Nov. 15, 2018

(54) CLEAR ALIGNER ORTHODONTIC SYSTEM WITH PREFABRICATED TOOTH ATTACHMENT

(71) Applicant: Yue Huang, Luzhou (CN)

(72) Inventor: Yue Huang, Luzhou (CN)

(21) Appl. No.: 15/979,517

(22) Filed: May 15, 2018

Related U.S. Application Data
(60) Provisional application No. 62/508,632, filed on May 19, 2017.

(30) Foreign Application Priority Data
May 15, 2017 (CN) 201710339041.7

(51) Int. Cl. A61C 7/08; A61C 7/00

(52) U.S. Cl. CPC A61C 7/08; A61C 9/004; A61C 7/002

(57) ABSTRACT

An orthodontic system comprises a prefabricated attachment applied to the labial or lingual side (or both) of one or more teeth, and a set of clear aligners. The prefabricated attachment comprise a base member sized and shaped to cover substantially the entire surface of the tooth to which it is attached, which provides a large adhesive surface area and hence superior adhesion. One or more attachments—sized and shaped smaller than the base member, and formed of a harder material—are affixed to the base member. The attachments, which may assume a wide variety of shapes, provide superior frictional fit to the aligner, thus increasing the amount of corrective force the aligner can apply to the teeth. In some embodiments, the attachments may have an undercut portion; an aligner may be formed to have a corresponding protrusion mating to the undercut, providing a firmer grip between the aligner and the tooth. In some embodiments, the attachments may include a passage operative to accept a pin having a feature such as a hook or eye, to which a wire or elastic band may be attached to apply additional corrective force to the tooth.

### CROSS-REFERENCE TO RELATED APPLICATIONS

This application is a non-provisional patent application which claims the benefit of U.S. Provisional Patent Application No. 62/508,632, filed May 19, 2017, and Chinese Application No. 201710339041.7, filed May 15, 2017, which are hereby incorporated by reference in their entirety.

### FIELD OF INVENTION

The present invention relates generally to orthodontics, and in particular to a prefabricated tooth attachment for use with clear aligner technology in orthodontic treatments.

### BACKGROUND

Orthodontics is the treatment of irregularities of the teeth, particularly alignment and occlusion. Since at least 1728, with the publication of “The Surgeon Dentist” by Pierre Fauchard, orthodontists have used various forms of braces to influence the position and alignment of teeth. Early attempts involved numerous methods, such as wrapping wire around individual teeth. Innovations in the 1970s included dental adhesives, allowing metal brackets to be mounted directly to the labial (outside) surface of teeth; the replacement of gold and silver by stainless steel, dramatically reducing costs; and the attachment of brackets to the lingual (inside) tooth surface, improving aesthetics. A mainstay of orthodontics from this time forward has been the use of wires or elastic bands mounted to brackets adhered to the teeth. The wires or bands apply tensile forces between the brackets (generally labial-side mounted), gradually realigning the teeth. While this method is effective and relatively easy to implement, many consider it unsightly and a detriment to an individual's aesthetic appearance. Additionally, traditional bracket & wire braces are difficult to clean, are uncomfortable in the patient's mouth, require a long time to install and periodically adjust, and may require a long treatment duration to achieve the desired alignment. Lingual-mounted bracket braces are largely invisible and hence address the aesthetics; however, they are very uncomfortable, affect pronunciation and chewing, adversely affect oral hygiene by making brushing more difficult, and they are more difficult for orthodontists to install and adjust.

In the late 1990s, a clear aligner was developed, and initially marketed under the name INVISALIGN®. A mold of the patient's teeth, or the teeth themselves, is imaged to create a 3-D digital model. This model may be adjusted using interactive computer software to a desired alignment. Software then suggests incremental, intermediate stages between the current and desired alignments, and clear plastic or acrylic aligners are created for the patent to wear, e.g., 20 hours a day for two weeks. Each aligner applies a small corrective force to the teeth by deformation of the aligner body, urging the teeth to an intermediate, or the final, alignment. A treatment may span, e.g., 13.5 months, and utilize several successive aligners. These products (also marketed as OTHOCLEAR® and CLEARCONNECT®) are popular due to their near-invisibility during normal use. They are also more comfortable than braces, and may be removed for eating and brushing. However, the effectiveness of clear aligners is questioned, particularly for certain types of realignments.

The Background section of this document is provided to place embodiments of the present invention in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, an orthodontic system comprises a prefabricated attachment applied to the labial or lingual side (or both) of one or more teeth, and a set of clear aligners. Because the attachment is prefabricated, it need not be formed of relatively soft resin having relative poor adhesion, as required by the manufacturing process for prior art attachments used with clear aligners. Accordingly, the prefabricated attachment is formed of a hard material, such as metal or ceramic. This allows the prefabricated attachment to assume a wide variety of shapes and sizes, to optimize grip between the teeth and the aligner, allowing the aligner to apply a broad variety of corrective forces. In one embodiment, the prefabricated attachment comprise a base member sized and shaped to cover substantially the entire surface of the tooth to which it is attached, which provides a large adhesive surface area and hence superior adhesion. Additionally, or alternatively, it may comprise one or more engagement features that provide superior grip with a clear aligner. Due to the hard material, the prefabricated attachment may include features such as an undercut to provide superior grip with an aligner. The prefabricated attachment may include a passage operative to accept a pin having an eye, hook, or other feature operative to connect to a wire or elastic band, allowing a hybrid approach utilizing traditional braces technology and clear aligners.

One embodiment relates to a method of aligning teeth. One or more attachments to be affixed to one or more teeth are fabricated. A computer model of the teeth and the attachment is generated. A first aligner, sized to conformally fit over the teeth with the attachment affixed thereto, is manufactured. The first aligner is applied over the teeth. The first aligner is conformally shaped to cover at least some of the teeth and to engage with the attachment, and is further shaped so as to exert a force on one or more teeth, urging them towards a desired alignment. The attachment is prefabricated at the time the first aligner is applied over the teeth.

Another embodiment relates to an orthodontic system operative to align teeth to a desired position and orientation. The system includes one or more prefabricated attachments to be affixed to one or more teeth; and a first aligner operative to be placed over the teeth. The aligner is conformally shaped to cover at least some of the teeth and to engage with the attachment, and is further shaped so as to exert a force on one or more teeth, urging them towards a desired alignment.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a perspective view of a clear aligner.

FIG. 2 depicts a set of aligners, each slightly differently shaped.

FIG. 3 is a perspective view of a set of teeth with attachments, each comprising a base member and engagement feature, applied to the lingual side of the teeth.

FIG. 4 is a perspective view of a set of teeth with attachments applied to the lingual side of the teeth, the attachments having differently shaped engagement members than those depicted in FIG. 3.

FIG. 5 depicts various sizes, shapes, and orientations of engagement members.

FIG. 6 depicts pins having features inserted into passages in engagement members.

FIG. 7 depicts a front and side view of an attachment wherein the engagement members each have an undercut portion.

FIG. 8 depicts an aligner with a wire embedded therein.

FIG. 9 is a flow diagram of a method of aligning teeth.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

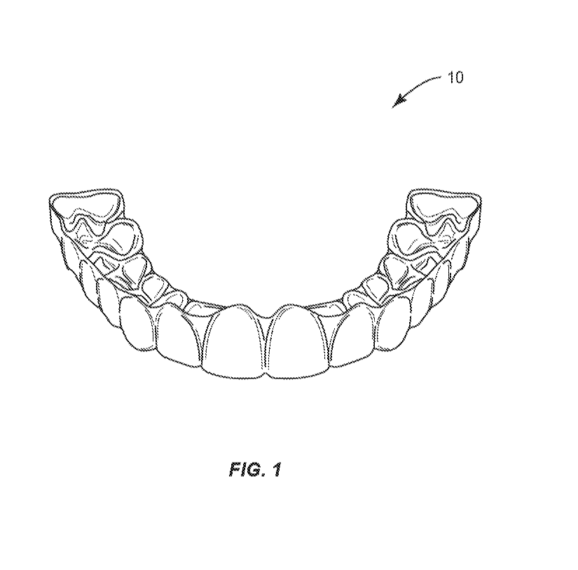

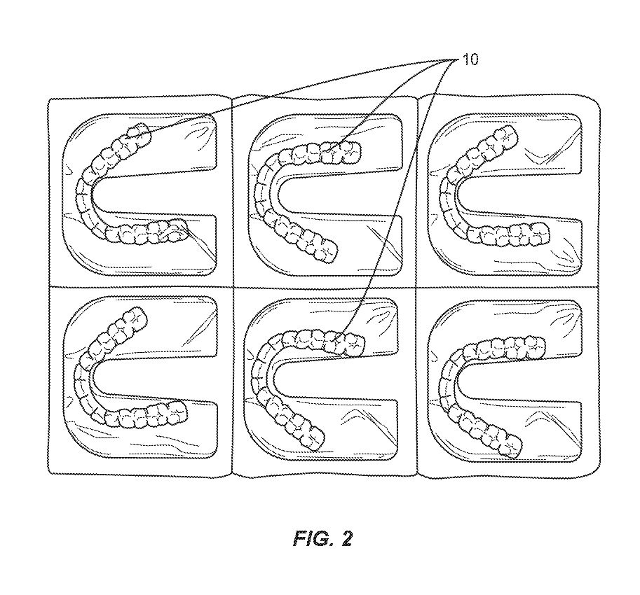

FIG. 1 depicts a clear orthodontic aligner 10. Clear aligners are the latest orthodontic development for patients needing realignment of their teeth, but who are concerned about aesthetics, hygiene, comfort, and the like. Orthodontic treatment using aligners comprises wearing successive aligners, each for, e.g., two weeks. Each successive aligner in the set is shaped slightly differently, and incrementally urges the teeth to a different alignment. FIG. 2 depicts a set of aligners 10.

Aligners are indicated for mild to moderate (e.g., 1-6 mm) crowning and spacing. This means they are ineffective in many orthodontic cases which may be treated by traditional braces. Indeed, the overall effectiveness of aligners 8 is unproven. A paper¹ published in 2014 by Rossini, et al., reviewing the peer-reviewed literature relevant to aligners 8, concluded:
CAT [Clear Alignment Technology] aligns and levels the arches; it is effective in controlling anterior intrusion but not anterior extrusion; it is effective in controlling posterior buccolingual inclination but not anterior buccolingual inclination; it is effective in controlling upper molar bodily movements of about 1.5 mm; and it is not effective in controlling rotation of rounded teeth in particular. ¹Rossini G., Parrini S, Castroflorio T, Deregibus A, and Debernardi C L, “Efficacy of clear aligners in controlling orthodontic tooth movement: a systematic review,” 20 Nov. 2014, available at https://www.ncbi.nlm.nih.gov/pubmed/25412265 last visited 5 Jun. 2017, the disclosure of which is incorporated herein by reference in its entirety.

One cause of the clear aligner's reduced effectiveness, with respect to traditional braces, is that the aligner does not “grip” individual teeth, as the brackets of traditional braces do. Rather, it relies on friction between the tooth surfaces and the aligner inner surfaces, and a bias force generated by deformation of the aligner body when applied over the teeth.

To improve the friction between the aligner and teeth, it is known to mount a resin attachment to one or more teeth. The resin may be clear, or colored to match the tooth color, to improve aesthetics. While the resin attachments may, in some cases, improve aligner performance, in general they have proven deficient in several respects, primarily due to the process by which the resin attachments are formed and applied.

Although in specific cases the methodology may vary, in general, clear aligners and resin tooth attachments for a given orthodontic treatment are manufactured and applied as follows. First, a 3-D software model of the patient's teeth is captured into a computer. This may comprise direct imaging of the teeth, or may comprise obtaining a bite-mold, casting a model of the teeth using the mold, and imaging the casting. Once a computer model of the teeth has been captured, computer models of small, usually rectangular, attachments are added to the surfaces of selected teeth in the computer models. Because they exist only in a 3-D model of the teeth in a computer system, these are referred to herein as “virtual attachments.”

The position and alignment of the teeth are then adjusted to obtain a desired, or targeted, alignment. Specialized 3-D modeling software then suggests a plurality of intermediate states, or alignments, of the teeth between the model representing the patient's actual teeth, and the targeted alignment. Each such intermediary alignment includes the “virtual” attachments affixed to the relevant surface(s) of selected teeth. For each intermediary alignment and the targeted alignment, the teeth are fabricated, such as by additive manufacturing, also known as 3-D printing. Because the 3-D model of each intermediary and the targeted alignment include the virtual attachments, the fabrications of the teeth include protrusions corresponding to the size, shape, and location of the virtual attachments.

An aligner is then created from each fabrication, or 3-D print of the teeth—that is, for each intermediary and the targeted alignment—such as by vacuum formation. Because the fabrications of the intermediary and targeted alignments of teeth include protrusions corresponding to the virtual attachments, the aligners include voids, or pockets, corresponding to these attachments. When the aligners are available and first fitted to the patient, an orthodontist fills these voids in the first aligner with an adhesive resin. The aligner is applied to the patient's teeth, and light is used to quickly cure the resin, and to activate its adhesion to the patient's teeth. Ideally, the attachments remain adhered to the teeth, as the patient cycles through the sequence of aligners corresponding to the intermediary and targeted alignments. Because each aligner was created from a fabrication of the 3-D model of the teeth that included the virtual attachments, each aligner includes voids, or pockets, corresponding to the resin attachments now adhered to the patient's teeth. Ideally, these attachments increase friction between the teeth and the aligner, and/or provide gripping points, both of which should allow the aligners to exert greater corrective force, and better adjust the patient's teeth.

This fabrication process imposes several limits on the resin attachments. Because the attachments are first formed by filling a void in an aligner—essentially, a mold—the choice of material is severely restricted. In particular, the resin attachments may only be made from material which begins as a viscous liquid (e.g., paste), and cures into a solid in response to exposure to predetermined wavelengths of light. Additionally, the material must be inherently adhesive to tooth enamel. In practice, the solid resin attachments are too soft to reproduce fine features, such as undercuts, rough or stippled surface texture features, passages that could accept pins, or the like. Additionally, in practice the adhesion is relatively poor, and the resin attachments are known to fall off of the teeth.

According to embodiments of the present invention, the efficacy of clear aligner technology orthodontic treatments is improved by attaching prefabricated attachments to the teeth, and manufacturing the aligners to accommodate the prefabricated attachments. As used herein, “prefabricated” means that the attachments are fabricated prior to the first aligner being applied over a patient's teeth. By separating the step of fabricating the attachments from the step of applying the first aligner to the patient's teeth, much greater freedom exists in the material, design, fabrication, and adherence of the attachments than what is available when the attachments are limited to an adhesive resin. For example, the attachments may be formed from much harder material, such as metal or ceramic, which may retain finer features, such as undercuts, stippled surfaces, wire attachment features, and the like. A greater variety of shapes are available, such as a large surface area base member for superior adhesion, with one or more engagement features formed over the base member for engagement with the aligner. Furthermore, a far greater range of adhesives is available for attachment to the teeth, allowing for more secure bonding and avoiding loss of the attachments. Indeed, conventional braces are applied by cementing metal brackets to tooth surfaces, and the industry has decades of experience in formulating and using cements to achieve strong adhesion.

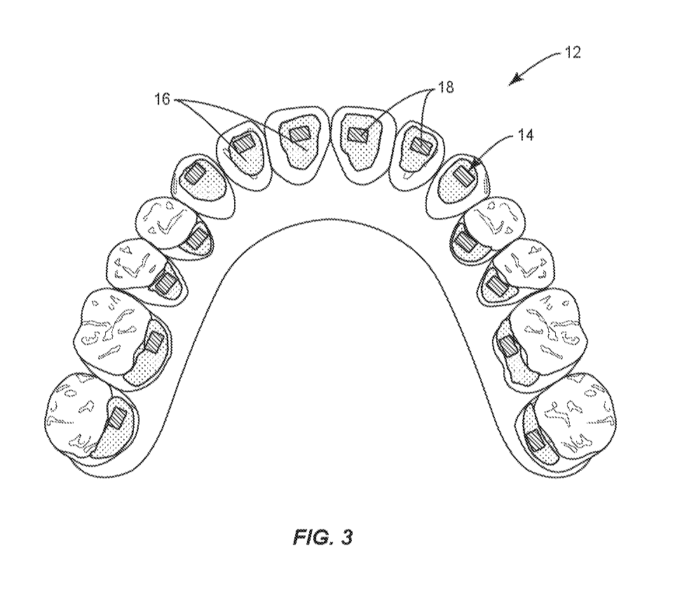

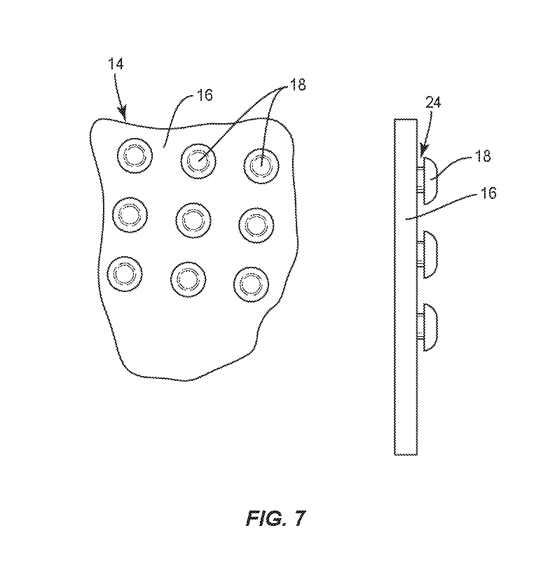

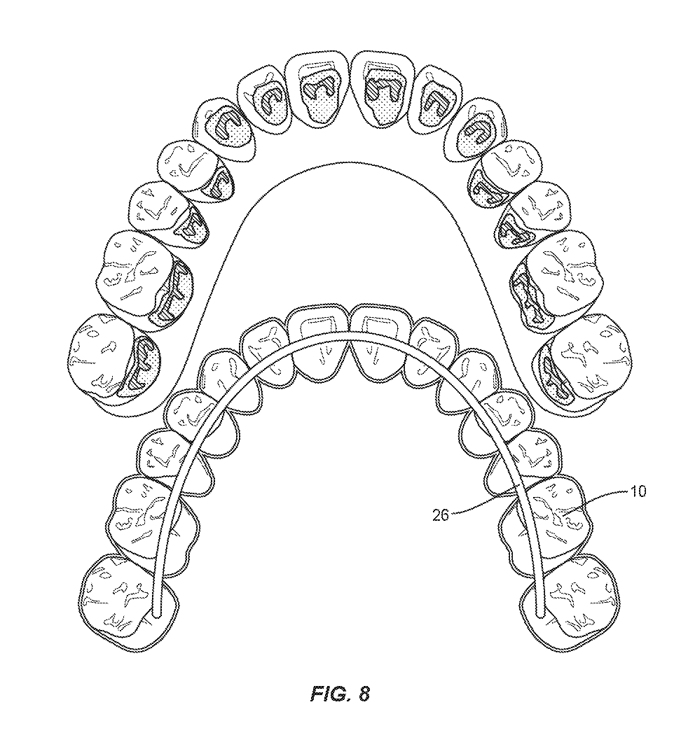

FIG. 3 depicts a set of teeth 12, with attachments 14 according to one embodiment attached to the lingual (interior) side of the teeth 10. In general, the attachments 14 may be attached to the lingual side, the labial (exterior) side, or to both. The attachments 14 depicted in FIG. 3 have a shape comprising two components: a base member 16 and one or more engagement features 18 (see also FIG. 7). Although FIG. 3 depicts the base members 16 as stippled and the engagement features 18 as hatched, this is to emphasize the shape, and does not imply that the components 16, 18 are formed of different materials, or that the attachment 14 is assembled from separate parts. Of course, the base member 16 and engagement features 18 could be formed from different materials and assembled together, but in preferred embodiments the attachment 14 is a unitary structure formed all from the same material.

Each base member 16 may be sized and shaped to cover substantially the entire surface of the side of the tooth 12 to which it is adhered. This size and shape of the base member 16 helps ensure that the attachment 14 remains firmly attached to the tooth 12, ideally throughout the entire duration of the orthodontic treatment. In some embodiments, the attachment 14 comprises only the base member 16 (that is, with no engagement features 18). In these embodiments, the outer surface of the attachment 14 may be formed to have a rough texture, such as by stippling or providing an etched or grooved surface. The rough texture may provide greater frictional force between the teeth 12 and the aligner 10, thus allowing the aligner 10 to exert a greater corrective force on the teeth 12.

On at least some attachments 14, one or more engagement features 18 protrude from the side of the base member 16 opposite that attached to the teeth 12. The engagement features 18, which in general may assume any shape or orientation, provide the aligner 10 with superior grip, allowing it to exert a greater corrective force on a patient's teeth. In some embodiments, such as where adhesion is not a challenge, the prefabricated attachment 14 may comprise only an engagement feature 18, without the underlying base member 16.

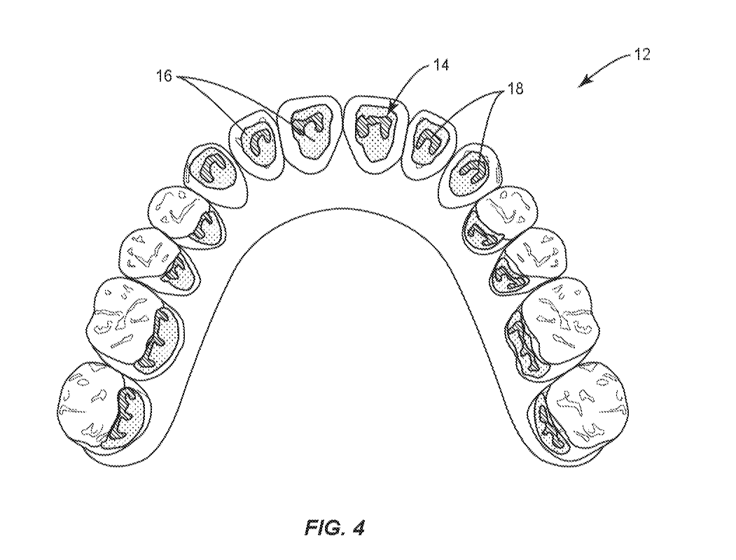

FIG. 4 depicts the set of teeth 12, with differently-shaped attachments 14. In this embodiment, the base members 16 are the same, but the engagement features 18 are shaped similar to an inverted “U” or “W.” In general, the engagement features 18 may assume any shape and orientation, as required or desired to provide optimal gripping force with the aligner 10 for a given desired alignment correction. For example, a targeted alignment to close a gap between the teeth may require a fundamentally differently directed corrective force than correction of an overbite. The engagement features 18 may be sized, shaped, and positioned so as to provide maximum gripping force the aligner 10, to enhance the desired corrective force.

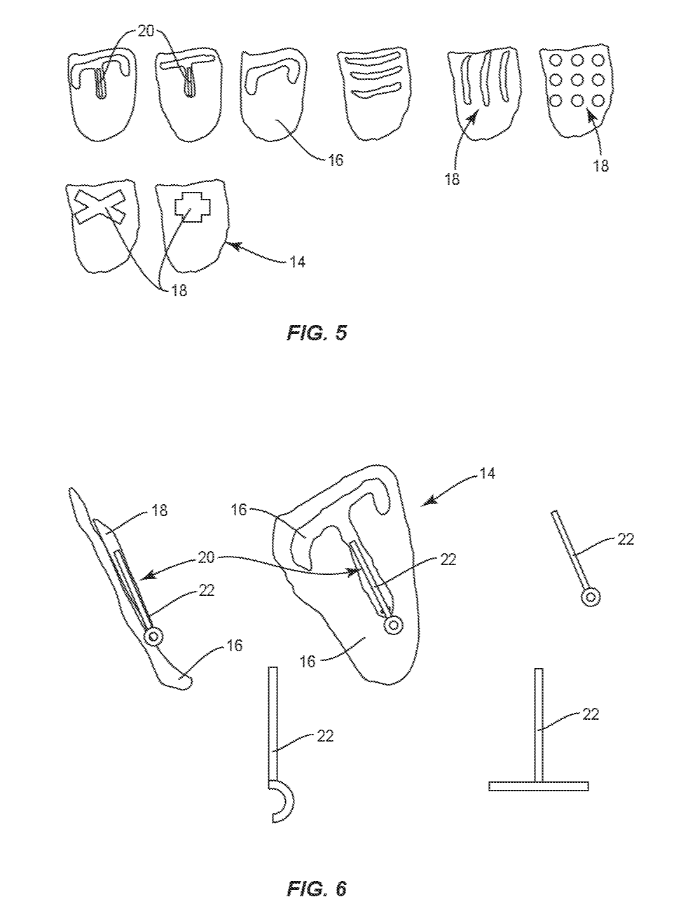

FIG. 5 depicts some representative shapes of engagement features 18. Note that the engagement features 18 may be singular or plural. They may be aligned vertically, horizontally, at any arbitrary angle, or any combination thereof. The engagement features 18 may be longitudinal, round, or shaped as an X, a +, a letter (T, U, W, V), or in any other shape.

In some embodiments, an engagement feature 18 may include a channel 20 formed therein. As depicted in FIG. 6, the channel 20 is operative to accept a pin 22. The pin 22 may include a hook, eye, “T” shape, or other feature at one end, providing a mounting point for a wire or elastic band. In these embodiments, at least some of the teeth 12 may be connected by wire or elastic band, providing far greater correction force than the aligner 10 alone may produce. In these embodiments, a groove or other feature may be designed into the aligner 10 to accommodate the wire or elastic band. Hence, traditional orthodontic methods and use of a clear aligner 10 are not mutually exclusive, but may be combined in embodiments of the present invention, allowing patients to take advantage of the benefits of each approach.

FIG. 7 depicts front and side views of a prefabricated attachment 14 in which the engagement features 18 include an undercut portion 24 where the engagement feature 18 joins the base member 14. In the embodiment depicted, the engagement features 18 are round; however, in general they may be of any arbitrary shape, and have the undercut portion 24. In some embodiments, the aligner 10 is formed to have a corresponding lip or protrusion on the interior surface, which is sized and shaped to at least partially engage the undercut portion 24 of one or more engagement features 18. This allows the aligner 10 to “grip” the tooth 12 more firmly, enabling the application of greater corrective force. For example, where the attachments 14 are mounted to the lingual side of the teeth 12, the aligner 10 may need to grip an engagement feature 18 using the undercut portion 24 to “pull” the tooth 12 inwardly (as well as “pushing” the teeth 12 inwardly by action of the outer side of the aligner 10). The undercut feature 24 is possible because the attachments 14 are formed of a harder material than the resin attachments of the prior art.

FIG. 8 depicts an aligner 10 including a wire 26 within the body of the aligner 10. In this embodiment, the wire 26 is not connected to a pin 22 inserted into a channel 20 of an engagement feature 18. Rather, the wire 26 is embedded within the plastic or acrylic aligner 10 body. In this embodiment, the wire 26 provides the aligner 10 with additional structural support, allowing it to exert greater alignment force on the teeth 12, where necessary. The aesthetics of this embodiment are still greater than with traditional braces, as the wire 26 may be embedded in the lingual side of the aligner 10, as shown. Alternatively, even when the wire 26 is mounted in the labial side of the aligner 10, it is not highly noticeable, since in practice, the aligner 10 is more translucent than perfectly clear, and will at least partially obscure the wire 26. Furthermore, embedding the wire 26 within the aligner 10 body eliminates the need for an orthodontist to attach the wire or elastic bands directly to the teeth 12, or to adjust the wire tension or location as realignment of the teeth 12 progresses.

To provide a full explanation of embodiments of the present invention, and their advantages over the prior art, embodiments of the process of making and using the present invention will be described. In one embodiment, attachments 14 are designed, fabricated, and attached to selected ones of a patient's teeth 12. In this regard, the process is, at least at the outset, similar to traditional braces, in which metal holders are cemented directly to a patient's teeth.

Once the attachments 14 are affixed to the patient's teeth 12, a computer model of the teeth 12 and attachments 14 is obtained. This may comprise imaging the teeth 12 with attachments 14 directly. Alternatively, a bite-mold of the teeth 12 and attachments 14 may be obtained, and a model cast using the mold. This casting is then imaged to obtain the computer model. In either case, a 3-D computer model of the patient's teeth 12—with the attachments 14 affixed—is stored.

As in the prior art, an orthodontist or technician then manipulates the 3-D computer model until the teeth 12 are in a desired, or target position and alignment. Specialized software then suggests a plurality of intermediate alignments. Once the intermediary alignments are selected, they (and the target alignment) are 3-D printed. Note that, since the attachments 14 were affixed to the teeth prior to obtaining the computer model, that model includes the attachments 14 on the teeth 12. Accordingly, each 3-D printed “positive” of the intermediary and final alignments includes protrusions exactly matching the attachments 14, when the teeth 12 are in the corresponding positions. In one embodiment, the surfaces of the teeth in the 3-D prints of intermediary and final alignments are roughened—either by manipulation of the computer models prior to printing, or by physically roughening the printed models. The rough surface will create a corresponding rough surface on the interior of the aligners formed from these models, which may provide greater gripping force during use on the patient's teeth 12.

Aligners 10 are then manufactured using the 3-D printed models of the teeth 12 and attachments 14 in the intermediary and final alignments, such as by vacuum molding, as known in the art. Each resulting aligner 10 includes pockets, or voids, precisely positioned and shaped to receive the attachments 14 that are already affixed to the patient's teeth.

However, the attachments 14 need not be affixed to the patient's teeth prior to manufacture of the aligners 10. In one embodiment, the attachments 14 are designed based on the forces that the aligners 10 must exert, and are fabricated and then imaged into the computer system to create 3-D models of the prefabricated attachments 14. The patient's teeth 12 are imaged, as described above. The computer models of the attachments 14 are then attached to the computer model of selected ones of the patient's teeth 12, in the desired locations and orientations, within the computer software environment. Note that, although affixing the attachments 14 to the teeth 12 is “virtual,” the attachments 14 are real—they were fabricated prior to being imaged into the computer system.

The orthodontic correction processes proceeds as described above, using the computer model of teeth 12 with attachments 14 affixed. This generates a plurality of aligners 10, each of which has a pocket, or void, sized and shaped to conformally cover each attachment 14. In this embodiment, the physical attachments 14 may be placed into these voids in the first aligner 10, prior to delivering the aligner 10 for introduction to the patient. After checking for fit, the orthodontist may then apply cement to the attachments 14 and apply the aligner 10 over the patient's teeth 12. In this manner, the attachments 14 need not be applied to the patient's teeth 12 until the aligner 10 is delivered. By using the voids in the aligner 10 to hold the attachments 14, precise initial placement and alignment on the patient's teeth is assured. However, because the attachments 14 are prefabricated, they are not limited to a resin, but rather may be formed of metal, ceramic, aluminum oxide, zirconia, or similar material that is much harder than the resin attachments of the prior art. The harder material allows for complex shapes, such as a base member 16 and engagement features 18. The hard material also allows for complex shapes for engagement features 18, such as passages 20 or undercuts 24.

As one variation on this procedure, in one embodiment, rather than fabricate the attachments 14 and image them for virtual attachment to a computer model of a patient's teeth, computer models of the attachments may be created in the computer system, or selected from a library of attachments. The attachments 14 are then fabricated, before or after the aligners are manufactured, such as by 3-D printing, computer controlled milling or machining, or other by other means. The prefabricated attachments 14 are then inserted into corresponding voids in the first aligner, and attached to the patient's teeth 12 when the first aligner is applied, as described above. In all of these variations, the attachments 14 are fully fabricated at the time the first aligner is applied to the patient's teeth 12. Because they are prefabricated, the attachments 14 may be formed of metal, ceramic, or similar hard substance, and may be attached to the teeth 12 using known strong cements. In these respects, the prefabricated attachments 14 are superior to resin attachments of the prior art, which are limited by the process of their formation to a relatively soft resin, which has relatively poor adhesion quality.

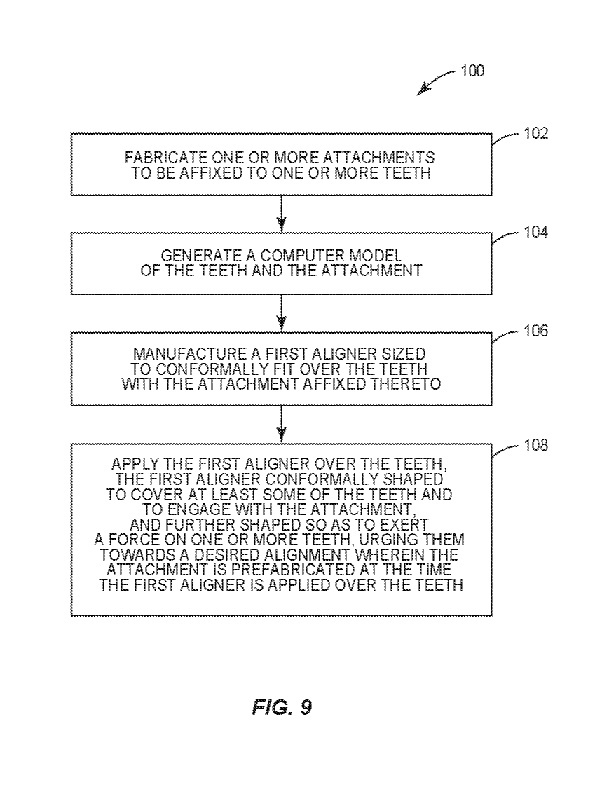

FIG. 9 depicts the steps in a method 100 of aligning teeth. One or more attachments 14, to be affixed to one or more teeth 12, are fabricated (block 102). The fabrication may be the first step performed, or it may follow creation or selection of the attachment 14 in a computer aided design system, and association with a computer model of the patient's teeth 12.

A computer model of the teeth 12 and the attachment 14 is generated (block 104). This may comprise affixing one or more attachments 14 to the teeth 12 and imaging or molding the teeth 12 and attachments 14 together. Alternatively, it may comprising imaging or molding the teeth 12, creating or selecting a computer model of the attachment, and associating the computer model of the attachment with the computer model of the teeth.

A first aligner 10, sized to conformally fit over the teeth 12 with the attachment 14 affixed thereto, is manufactured (block 106). The first aligner 10 is applied over the teeth 12 (block 108). The first aligner 10 is conformally shaped to cover at least some of the teeth 12 and to engage with the attachment 14, and further shaped so as to exert a force on one or more teeth 12, urging them towards a desired alignment.

The attachment 14 is prefabricated at the time the first aligner 10 is applied over the teeth 12 (block 108). The attachment 14 may have been prefabricated and applied to the teeth 12 prior to their imaging into the computer system. Alternatively, the prefabricated attachment 14 may have been separately imaged, and a computer model of the attachment added to the computer model of the teeth. In the latter case, the attachments 14 may be placed into associated voids in the first aligner 10, which then serves as a guide to placement while they are cemented to the teeth 12. As still another alternative, a computer model of the attachment may have been created, or selected from a library, in the computer system, and the attachment 14 fabricated before, after, or concurrently with the first aligner being manufactured. In this case, the attachments 14 may also be inserted into corresponding voids in the aligner 10 prior to applying the first aligner to the patient's teeth 12.

After a predetermined duration of use, the first aligner may be replaced with a second aligner shaped to apply at least a slightly different force to the teeth than the first aligner.

Embodiments of the present invention provide numerous advantages over the prior art. The advantages of clear aligners over conventional braces are well known, but suffer the deficiency of low corrective force due to reliance on friction between the aligner 10 and tooth 12 surface. The use of resin attachments to increase the friction between the aligner 10 and teeth 12 suffers the known deficiencies that, due to the soft material, the resin attachments are limited in the shapes they may be formed into, and additionally the resin attachments are prone to fall off, due to poor adhesion. In embodiments of the present invention, the attachments 14 are prefabricated at the time the first aligner is applied. As such, the in situ resin-hardening process required to form the prior art attachments is not required. This allows the attachments 14 to be formed in a large variety of shapes, such as including a relatively large base member 16 for superior adhesion to a tooth 12 surface, and/or complex engagement features 18 for superior grip by the aligner 10. The engagement features 18 may include features such as an undercut 24 or a passage 20 operative to hold a pin 22 which may connect to a wire or elastic band for further corrective force. The interior of the aligner 10 may be formed to have a rough texture, increasing the frictional hold between the aligner 10 and the teeth 12. The aligner 10 may have one or more wires for structural support.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of aligning teeth, comprising:
fabricating one or more attachments to be affixed to one or more teeth;
generating a computer model of the teeth and the attachment;
manufacturing a first aligner sized to conformally fit over the teeth with the attachment affixed thereto; and
applying the first aligner over the teeth, the first aligner conformally shaped to cover at least some of the teeth and to engage with the attachment, and further shaped so as to exert a force on one or more teeth, urging them towards a desired alignment;
wherein the attachment is prefabricated at the time the first aligner is applied over the teeth.

2. The method of claim 1 wherein the attachment is transparent or colored to match the tooth.

3. The method of claim 1 wherein the attachment is formed of metal, ceramic, aluminum oxide, or zirconia.

4. The method of claim 1 wherein the attachment includes an undercut portion.

5. The method of claim 4 wherein when placed over the teeth, some aligner material extends at least partially into the undercut portion space, so as to provide a greater coupling between the aligner and the tooth.

6. The method of claim 1 wherein the attachment includes a passage or hook operative to accept a wire or elastic band.

7. The method of claim 6 wherein the aligner includes a groove to accept a wire or elastic band.

8. The method of claim 6 further comprising a wire or elastic band between two or more attachments, the wire or elastic band operative to exert greater force on the teeth than the aligner and attachments alone.

9. The method of claim 1 wherein the attachment is affixed to the labial side of a tooth.

10. The method of claim 1 wherein the attachment is affixed to the lingual side of a tooth.

11. The method of claim 1 wherein the aligner has a wire member embedded within it.

12. The method of claim 1, further comprising, after a predetermined duration of use of the first aligner, replacing the first aligner with a second aligner shaped to apply at least slightly different force to the teeth.

13. The method of claim 1, further comprising, after fabricating the attachment:
affixing one or more attachments to one or more teeth; and
wherein generating a computer model of the teeth and the attachment comprises obtaining a computer model of the teeth with the attachment affixed thereto.

14. The method of claim 13 wherein obtaining a computer model of the teeth with the attachment affixed thereto comprises imaging the teeth with the attachment affixed thereto.

15. The method of claim 13 wherein obtaining a computer model of the teeth with the attachment affixed thereto comprises:
obtaining an impression of the teeth with the attachment affixed thereto;
creating a model of the teeth with the attachment affixed thereto from the impression; and
imaging the model of the teeth with the attachment affixed thereto.

16. The method of claim 1 further comprising, after fabricating the attachment:
generating a computer model of the attachment by imaging the attachment;
generating a computer model of the teeth by imaging the teeth without the attachment affixed thereto; and
wherein generating a computer model of the teeth and the attachment comprises combining the computer models of the teeth and of the attachment.

17. The method of claim 16 further comprising:
after manufacturing the first aligner, inserting the attachment into the first aligner in a position conformally shaped to cover the attachment.

18. The method of claim 17 further comprising:
affixing the attachment to the teeth upon applying the first aligner over the teeth.

19. An orthodontic system operative to align teeth to a desired position and orientation, comprising:
one or more prefabricated attachments to be affixed to one or more teeth; and
a first aligner operative to be placed over the teeth, the aligner conformally shaped to cover at least some of the teeth and to engage with the attachment, and further shaped so as to exert a force on one or more teeth, urging them towards a desired alignment.

20. The system of claim 1 wherein the attachment is transparent or colored to match the tooth.

21. The system of claim 1 wherein the attachment is formed of metal, ceramic, aluminum oxide, or zirconia.

22. The system of claim 1 wherein the attachment includes an undercut portion.

23. The system of claim 22 wherein when placed over the teeth, some aligner material extends at least partially into the undercut portion space, so as to provide a greater coupling between the aligner and the tooth.

24. The system of claim 1 wherein the attachment includes a passage or hook operative to accept a wire or elastic band.

25. The system of claim 24 wherein the aligner includes a groove to accept a wire or elastic band.

26. The system of claim 24 further comprising a wire or elastic band between two or more attachments, the wire or elastic band operative to exert greater force on the teeth than the aligner and attachments alone.

27. The system of claim 1 wherein the attachment is affixed to the labial side of a tooth.

28. The system of claim 1 wherein the attachment is affixed to the lingual side of a tooth.

29. The system of claim 1 wherein the aligner has a wire member embedded within it.

30. The system of claim 1, further comprising a second aligner shaped to apply at least slightly different force to the teeth than the first aligner.
